(19) United States
(12) Patent Application Publication
(10) Pub. No.: US 2024/0269863 A1
(43) Pub. Date: Aug. 15, 2024

(54) Clamping Device and Installation System

(71) Applicants: TE Connectivity Solutions GmbH, Schaffhausen (CH); Tyco Electronics (Shanghai) Co., Ltd., Shanghai (CN); Kunshan League Automechanism Co., Ltd, Kunshan City (CN)

(72) Inventors: Rong Zhang, Shanghai (CN); Roberto Francisco-Yi Lu, Bellevue, WA (US); Dandan (Emily) Zhang, Shanghai (CN); Lei (Alex) Zhou, Shanghai (CN); Zongjie (Jason) Tao, Shanghai (CN); Xianghao (Jorge) Bao, Shanghai (CN); Yong Wang, Kunshan City (CN); Haidong Wu, Kunshan City (CN)

(73) Assignees: TE Connectivity Solutions GmbH, Schaffhausen (CH); Tyco Electronics (Shanghai) Co., Ltd., Shanghai (CN); Kunshan League Automechanism Co., Ltd, Kunshan City (CN)

(21) Appl. No.: 18/434,978

(22) Filed: Feb. 7, 2024

(30) Foreign Application Priority Data
Feb. 9, 2023 (CN) 202310099260.8

(51) Int. Cl. B25J 15/00; B25J 5/00; B25J 15/02; B25J 15/04; B25J 19/04

(52) U.S. Cl. CPC B25J 15/0028; B25J 15/0033; B25J 15/0253; B25J 15/0408; B25J 5/007; B25J 19/04

(57) ABSTRACT

A clamping device includes an installation plate and a pair of clamping claws installed on the installation plate. One of the clamping claws has a first clamping surface and the other has a second clamping surface. The first clamping surface contacts a side of a fixed part of the elastic contact member and a row of first elastic arms. The second clamping surface contacts another side of the fixed part and a row of second elastic arms. The first clamping surface matches an outer surface of the side of the fixed part and a plurality of outer surfaces of the row of first elastic arms, the second clamping surface matches an outer surface of the other side of the fixed part and a plurality of outer surfaces of the row of second elastic arms. A clamping force applied by the clamping claws is evenly distributed on the elastic contact member.

### CROSS-REFERENCE TO RELATED APPLICATION

This application claims the benefit of the filing date under 35 U.S.C. § 119(a)-(d) of Chinese Patent Application No. 202310099260.8, filed on Feb. 9, 2023.

### FIELD OF THE INVENTION

The present invention relates to a clamping device, in particular to a clamping device for clamping an elastic contact member. The present invention also relates to an installation system including the clamping device, which is used for assembling the elastic contact member onto a shell.

### BACKGROUND

In the prior art, a connector typically includes a shielding shell and elastic contact members assembled on the shielding shell. An elastic contact member usually includes a fixed part with a U-shaped cross-section and a row of first and second elastic arms connected to both sides of the opening of the fixed part. When the elastic contact member is assembled onto the shielding shell, the fixed part of the elastic contact member is clamped on the edge of the opening of the shielding shell and welded or riveted to the edge of the opening of the shielding shell. The first and second elastic arms of the elastic contact member are located on the inner and outer sides of the edge of the opening of the shielding shell, respectively.

In the prior art, the thickness of the elastic contact member is very thin, usually less than 0.1 mm, which makes it easy to deform and difficult to assemble. Currently, an operator is required to manually assemble the elastic contact member, which will result in higher labor costs and assembly time. In addition, in the prior art, the assembly quality and efficiency of the elastic contact member largely depends on the experience of the operator, which leads to unreliable assembly quality and low assembly efficiency.

### SUMMARY

A clamping device includes an installation plate and a pair of clamping claws installed on the installation plate. One of the clamping claws has a first clamping surface and the other has a second clamping surface. The first clamping surface contacts a side of a fixed part of the elastic contact member and a row of first elastic arms. The second clamping surface contacts another side of the fixed part and a row of second elastic arms. The first clamping surface matches an outer surface of the side of the fixed part and a plurality of outer surfaces of the row of first elastic arms, the second clamping surface matches an outer surface of the other side of the fixed part and a plurality of outer surfaces of the row of second elastic arms. A clamping force applied by the clamping claws is evenly distributed on the elastic contact member.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of an elastic contact member according to an exemplary embodiment of the present invention;

FIG. 2 shows an illustrative perspective view of an installation system according to an exemplary embodiment of the present invention;

FIG. 3 shows an illustrative perspective view of a clamping device according to an exemplary embodiment of the present invention;

FIG. 4 shows a side view of a clamping device according to an exemplary embodiment of the present invention;

FIG. 5 shows a partially enlarged view of a clamping device according to an exemplary embodiment of the present invention;

FIG. 6 shows a front view of a clamping device according to an exemplary embodiment of the present invention;

FIG. 7 shows a front view of a clamping device according to another exemplary embodiment of the present invention;

FIG. 8 shows an illustrative perspective view of a loading device according to an exemplary embodiment of the present invention;

FIG. 9 shows an illustrative view of a loading slot of a carrier of a loading device according to an exemplary embodiment of the present invention; and

FIG. 10 shows an illustrative view of an input channel of a carrier of a loading device according to an exemplary embodiment of the present invention.

### DETAILED DESCRIPTION OF EXEMPLARY EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

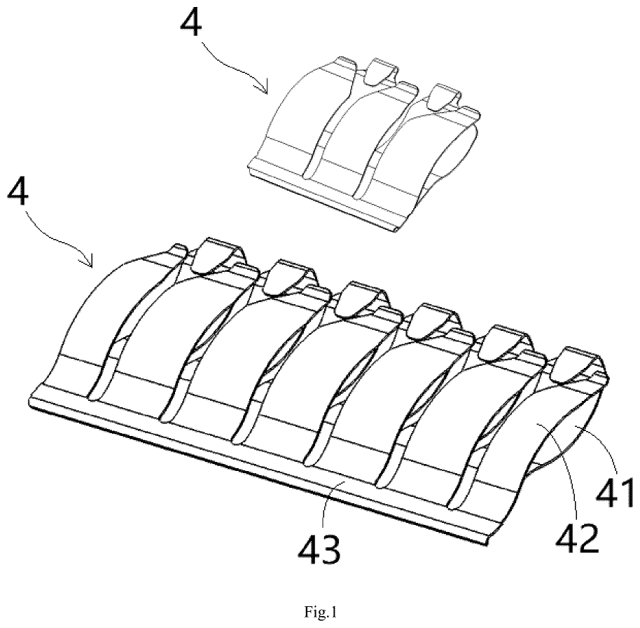

FIG. 1 shows an illustrative perspective view of the elastic contact member 4 according to an exemplary embodiment of the present invention. As shown in FIG. 1, in the illustrated embodiment, the elastic contact member 4 includes a fixed part 43 with a U-shaped cross-section and a row of first elastic arms 41 and a row of second elastic arms 42 connected to both sides of the opening of the fixed part 43, respectively. In the illustrated embodiment, the elastic contact member 4 is an integral stamped piece formed by stamping a single metal sheet. The thickness of the elastic contact member 4 may be less than 0.1 mm, for example, it can be 0.06 mm. Therefore, when assembling the elastic contact member 4 onto a shell of a connector (such as a shielding shell of a connector), it is easy to damage due to uneven or excessive force.

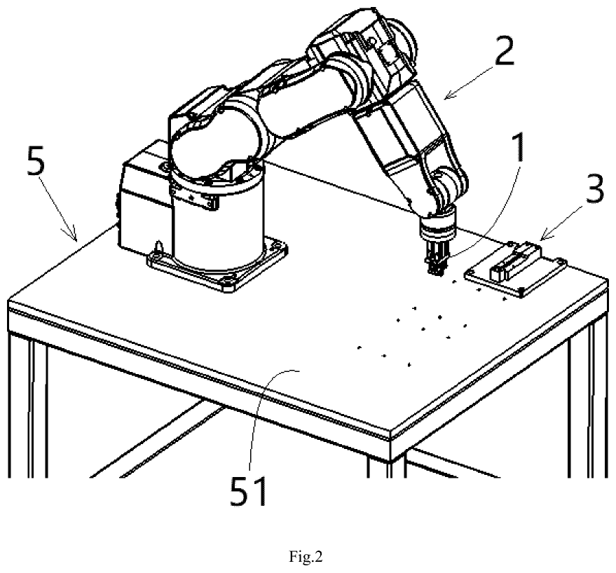

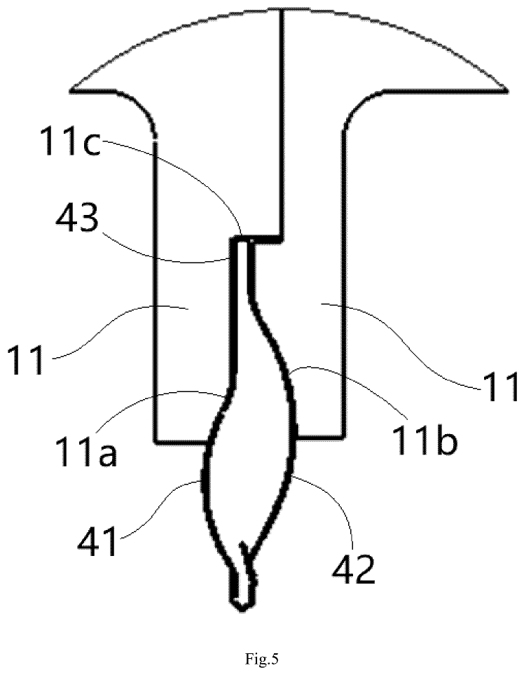

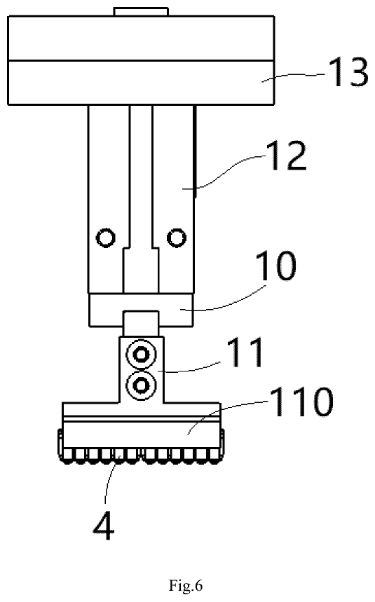

As shown in FIGS. 2-6, in an exemplary embodiment of the present invention, a clamping device 1 is disclosed. The clamping device 1 includes: an installation plate 10; and a pair of clamping claws 11 installed on the installation plate 10. One of the pair of clamping claws 11, as shown in FIG. 5, has a first clamping surface 11a for contacting one side of the fixed part 43 of the elastic contact member 4 and contacting first portions of the row of first elastic arms 41 connected to the fixed part 43. The other of the pair of clamping claws 11, as shown in FIG. 5, has a second clamping surface 11b for contacting the other side of the fixed part 43 of the elastic contact member 4 and second portions of the row of second elastic arms 42 connected to the fixed part 43.

As shown in FIG. 5, the first clamping surface 11a is formed to match the outer surface of one side of the fixed part 43 and match the first portions of the row of first elastic arms 41, while the second clamping surface 11b is formed to match the outer surface of the other side of the fixed part 43 and match the second portions of the row of second elastic arms 42, to ensure that the clamping force applied by the pair of clamping claws 11 on the elastic contact member 4 is evenly distributed.

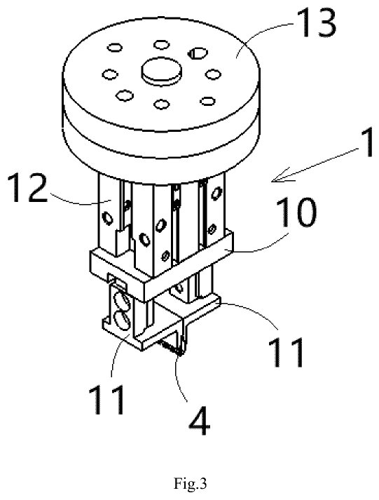

As shown in FIGS. 3, 4, 6, and 7, in the illustrated embodiment, the clamping device 1 further includes a driving device 12, which is installed on the installation plate 10 to drive the pair of clamping claws 11 to close or open, so as to clamp or release the elastic contact member 4. The clamping force applied by the driving device 12 to the pair of clamping claws 11 can be adjusted to ensure that the clamping force does not exceed the maximum clamping force that the elastic contact member 4 can withstand. In an exemplary embodiment of the present invention, the driving device 12 may be a servo electric cylinder or a servo air cylinder.

In the illustrated embodiment, one of the pair of clamping claws 11 also has a positioning surface 11c, shown in FIG. 5, for abutting against the bottom surface of the fixed part 43. The positioning surface 11c is formed to match the bottom surface of the fixed part 43.

As shown in FIGS. 1, 4, and 5, in the illustrated embodiment, the outer surfaces of the first elastic arm 41 and the second elastic arm 42 are arc-shaped, and a portion of the first clamping surface 11a and a portion of the second clamping surface 11b are arc-shaped, used for clamping on a portion of the first elastic arm 41 and a portion of the second elastic arm 42, respectively. In the illustrated embodiment, the shape and/or size of the outer surface of the first elastic arm 41 is different from that of the outer surface of the second elastic arm 42, and the shape and/or size of the first clamping surface 11a is different from that of the second clamping surface 11b.

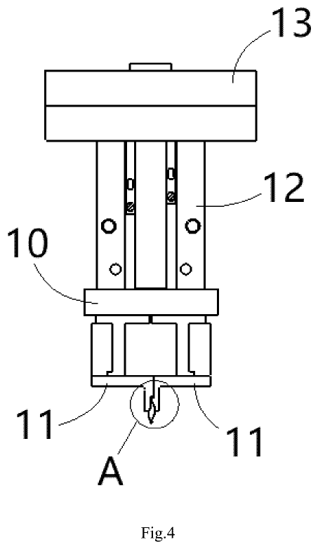

As shown in FIGS. 3 and 4, in the illustrated embodiment, the clamping device 1 further includes a connecting plate 13, which is fixed to the driving device 12 and used to connect to an end of a robot 2 to install the clamping device 1 on the robot 2.

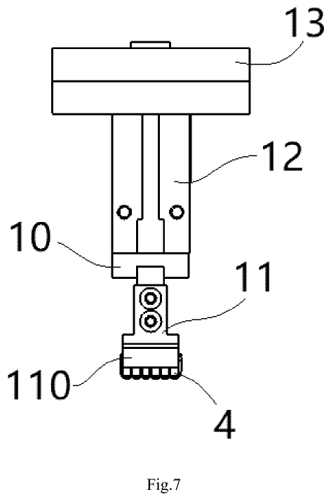

FIG. 7 shows a front view of the clamping device 1 according to another exemplary embodiment of the present invention.

The clamping claws 11 can be detachably installed on the installation plate 10, enabling the replacement of clamping claws 11 of different sizes and/or shapes to grip elastic contact members 4 of different sizes and/or shapes, such as the two different sizes of elastic contact members 4 shown in FIGS. 1, 6, and 7. In this way, the application range and compatibility of the clamping device 1 can be expanded.

As shown in FIG. 2, in another exemplary embodiment of the present invention, an installation system is disclosed. This installation system is used to assemble the elastic contact member 4 onto the shell of the connector. The installation system includes: a robot 2 and a clamping device 1. The clamping device 1 is connected to the end of robot 2. Robot 2 can grasp the elastic contact member 4 and assemble the grasped elastic contact member 4 onto the shell by the clamping device 1. The installation system also includes a visual device enabling the robot 2 to grasp the elastic contact member 4 and assemble the grasped elastic contact member 4 onto the shell under the visual guidance of the visual device. In an embodiment, the robot 2 is a multi-degree of freedom robot, such as a six-axis robot or other suitable multi degree of freedom robot.

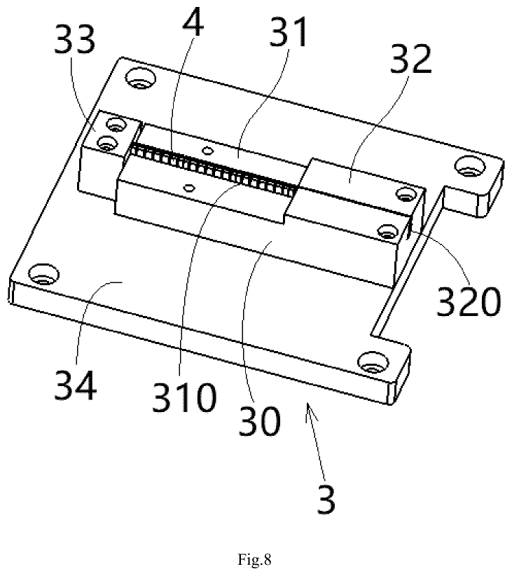

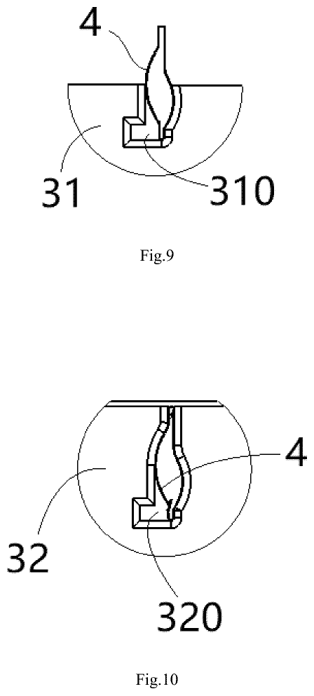

In an embodiment, as shown in FIGS. 2 and 8-10, the installation system further includes a loading device 3 for loading the elastic contact member 4 to be assembled. Robot 2 grabs the elastic contact member 4 from the loading device 3 by the clamping device 1. FIG. 8 shows an illustrative perspective view of a loading device 3 according to an exemplary embodiment of the present invention. FIG. 9 shows an illustrative view of a loading slot 310 of a carrier 30 of the loading device 3 according to an exemplary embodiment of the present invention; FIG. 10 shows an illustrative view of an input channel 320 of the carrier 30 of the loading device 3 according to an exemplary embodiment of the present invention.

As shown in FIG. 8, in the illustrated embodiment, the loading device 3 includes a carrier 30, on which the loading slot 310 is formed for loading the elastic contact member 4. The elastic contact member 4 is loaded into the loading slot 310, and the fixed part 43 of the elastic contact member 4 and a part connected to the fixed part 43 are exposed from the top opening of the loading slot 310. The clamping device 1 is clamped on the portion of the elastic contact member 4 that is exposed from the top opening of the loading slot 310.

As shown in FIGS. 8 and 9, in the illustrated embodiments, at least a portion of the inner side of the loading slot 310 is in contact with the outer side of the elastic contact member 4, and at least a portion of the inner side of the loading slot 310 is formed to match the elastic contact member 4 to stably maintain the elastic contact member 4 in the loading slot 310.

As shown in FIGS. 8 to 10, in the illustrated embodiment, the carrier 30 includes a main body part 31 and an input part 32. A loading slot 310 is formed on the main body part 31. The input part 32 is located at one end of the main body part 31, and an input channel 320 is formed in the input part 32. The input channel 320 is connected to one end of the loading slot 310 to allow the elastic contact member 4 to be transported into the loading slot 310 through the input channel 320.

In an embodiment, the installation system further includes a vibration feeding device, which is used to transport the elastic contact member 4 to the input channel 320 of the carrier 30. The vibration feeding device has a feeding channel, and the feeding channel of the vibration feeding device is connected to the inlet of the input channel 320 of the carrier 30.

As shown in FIG. 10, in the illustrated embodiments, at least a portion of the inner surface of the input channel 320 of the carrier 30 contacts the outer surface of the elastic contact member 4, and at least a portion of the inner surface of the input channel 320 is formed to match the elastic contact member 4 to stably position the elastic contact member 4 in the input channel 320.

As shown in FIG. 8, in the illustrated embodiment, the loading device 3 further includes a base 34 and a stopper 33. The carrier 30 and the stopper 33 are fixed on the base 34. The stopper 33 faces the end face of the other end of the main body part 31 of the carrier 30. The loading slot 310 extends to the end face of the other end of the main body part 31 of the carrier 30, and the stopper 33 is used to rest against one end of the elastic contact member 4 loaded in the loading slot 310 to position the elastic contact member 4 in the length direction of the loading slot 310.

As shown in FIG. 2, in the illustrated embodiment, the installation system further includes a support platform 5, which has a support plate 51 located at its top. Robot 2 and loading device 3 are fixed on the support plate 51 of the support platform 5. In an embodiment of the present invention, wheels can be installed at the bottom of the support platform 5, allowing the support platform 5 to move freely.

In the aforementioned exemplary embodiments of the present invention, the clamping force applied by the clamping device to the elastic contact member is controllable and evenly distributed, thereby effectively preventing the elastic contact member from being damaged due to excessive or uneven force. In addition, in the present invention, the installation system including the clamping device can achieve automated assembly of elastic contact members, greatly improving the assembly efficiency and quality of elastic contact members.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A clamping device for gripping an elastic contact member, comprising:
an installation plate; and
a pair of clamping claws installed on the installation plate, one of the pair of clamping claws has a first clamping surface and the other of the pair of clamping claws has a second clamping surface, the elastic contact member includes a fixed part having a U-shaped cross-section with a row of first elastic arms and a row of second elastic arms connected to a pair of sides of an opening of the fixed part, the first clamping surface contacts a side of the fixed part and a plurality of first portions of the row of first elastic arms, the second clamping surface contacts another side of the fixed part and a plurality of second portions of the row of second elastic arms, the first clamping surface matches an outer surface of the side of the fixed part and a plurality of outer surfaces of the first portions of the row of first elastic arms, the second clamping surface matches an outer surface of the another side of the fixed part and a plurality of outer surfaces of the second portions of the row of second elastic arms, a clamping force applied by the pair of clamping claws is evenly distributed on the elastic contact member.

2. The clamping device according to claim 1, further comprising a driving device on the installation plate driving the pair of clamping claws to close or open, to clamp or release the elastic contact member, the clamping force applied by the driving device to the pair of clamping claws is adjustable.

3. The clamping device according to claim 2, wherein the clamping jaws are detachably installed on the installation plate, enabling the replacement of clamping jaws of different sizes and/or shapes to grip elastic contacts of different sizes and/or shapes.

4. The clamping device according to claim 1, wherein one of the pair of clamping claws has a positioning surface abutting against a bottom surface of the fixed part, the positioning surface matches the bottom surface of the fixed part.

5. The clamping device according to claim 1, wherein the outer surfaces of the first portions of the row of first elastic arms and the second portions of the row of second elastic arms are curved, and a portion of the first clamping surface and a portion of the second clamping surface are curved.

6. The clamping device according to claim 1, wherein a shape and/or a size of the outer surfaces of the first portions of the row of first elastic arms are different from the outer surfaces of the second portions of the row of second elastic arms, and a shape and/or a size of the first clamping surface is different from the second clamping surface.

7. The clamping device according to claim 2, further comprising a connecting plate fixed to the driving device and connecting to an end of a robot to install the clamping device onto the robot.

8. The clamping device according to claim 2, wherein the driving device is a servo electric cylinder or a servo air cylinder.

9. An installation system for assembling an elastic contact member onto a shell, comprising:
a robot; and
a clamping device connected to an end of the robot, the connecting device grips an elastic contact member, the clamping device includes an installation plate and a pair of clamping claws installed on the installation plate, one of the pair of clamping claws has a first clamping surface and the other of the pair of clamping claws has a second clamping surface, the elastic contact member includes a fixed part having a U-shaped cross-section with a row of first elastic arms and a row of second elastic arms connected to a pair of sides of an opening of the fixed part, the first clamping surface contacts a side of the fixed part and a plurality of first portions of the row of first elastic arms, the second clamping surface contacts another side of the fixed part and a plurality of second portions of the row of second elastic arms, the first clamping surface matches an outer surface of the side of the fixed part and a plurality of outer surfaces of the first portions of the row of first elastic arms, the second clamping surface matches an outer surface of the another side of the fixed part and a plurality of outer surfaces of the second portions of the row of second elastic arms, a clamping force applied by the pair of clamping claws is evenly distributed on the elastic contact member, the robot grips the elastic contact member and assembles the elastic contact member onto the shell by the clamping device.

10. The installation system according to claim 9, further comprising a visual device for visually guiding the robot to grip the elastic contact member and assemble the elastic contact member onto the shell.

11. The installation system according to claim 9, wherein the robot is a multi-degree of freedom robot.

12. The installation system according to claim 9, further comprising a loading device loading the elastic contact member, the robot grips the elastic contact member from the loading device by the clamping device.

13. The installation system according to claim 12, wherein the loading device includes a carrier formed with a loading slot for loading the elastic contact member, the elastic contact member is loaded into the loading slot, the fixed part of the elastic contact member and a part connected to the fixed part are exposed from a top opening of the loading slot, the clamping device is clamped on a portion of the elastic contact member that is exposed from the top opening of the loading slot.

14. The installation system according to claim 13, wherein a part of an inner side of the loading slot contacts an outer side of the elastic contact member, and another part of the inner side of the loading slot matches the elastic contact member.

15. The installation system according to claim 13, wherein the carrier includes a main body part formed with the loading slot and an input part located at an end of the main body part, an input channel is formed in the input part, the input channel communicates with an end of the loading slot and the elastic contact member is transported into the loading slot through the input channel.

16. The installation system according to claim 15, further comprising a vibration feeding device conveying the elastic contact member to the input channel of the carrier, the vibration feeding device has a feeding channel connected to an inlet of the input channel of the carrier.

17. The installation system according to claim 15, wherein a part of an inner side of the input channel is in contact with an outer side of the elastic contact member, and another part of the inner side of the input channel matches the elastic contact member.

18. The installation system according to claim 15, wherein the loading device includes a base on which the carrier is fixed and a stopper fixed on the base and facing an end face of another end of the main body part of the carrier, the loading slot extends to the end face of the another end of the main body part of the carrier, the stopper rests against an end of the elastic contact member loaded in the loading slot to position the elastic contact member in a length direction of the loading slot.

19. The installation system according to claim 13, further comprising a support platform having a support plate at a top of the support platform, the robot and the loading device are fixed on the support plate of the support platform.

20. The installation system according to claim 19, wherein a plurality of wheels are installed at a bottom of the support platform.
